(19) United States
(12) Patent Application Publication
(10) Pub. No.: US 2008/0174809 A1
(43) Pub. Date: Jul. 24, 2008

(54) SYSTEM AND METHOD FOR CONFIGURATION CLONING FOR DOCUMENT PROCESSING DEVICES

(76) Inventors: Andrey Savov, Fullerton, CA (US); Silvy Wilson, Rancho Santa Margari, CA (US); Fabio Gava, Ladera Ranch, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,820

(22) Filed: Jan. 24, 2007

(51) Int. Cl. G06F 15/00

(52) U.S. Cl. 358/1.15

(57) ABSTRACT

The subject application is directed to a configuration cloning system and method for document processing devices. Configuration data, representing a suitable configuration for implementation by the receiving document processing device, is first received by at least one document processing device. The document processing device then commences operations based upon the received configuration data. The configuration data is then tested by the document processing device. Depending upon the outcome of the testing by the document processing device, the received configuration data is transferred to at least one additional document processing device via a computer network.

### BACKGROUND OF THE INVENTION

The subject application is directed to a system and method for configuration cloning for document processing devices. In particular, the subject application is directed to a system and method for continuously updating the configuration of a plurality of networked document processing devices.

A company, university, hospital, or other type of large entity will typically have a number of document processing devices, such as multifunctional peripheral device, available for use by its employees. In order to maintain or improve the functionality of such document processing devices, the manufacturers of such devices will offer updates, upgrades, maintenance fixes, or other types of software to be installed on the devices. One current option for updating the devices of an entity is for an administrator to install such update on one device and perform a test to determine the acceptability of such update. The administrator must then install the update on each device. Another option is for the update to be installed on one device for testing, and upon acceptability of the update, an update server distributes the updates to each device.

It would be desirable to have a system and method for continuously updating the configuration of a plurality of networked document processing devices. The subject application overcomes the above noted problems and provides a system and method for configuration cloning for document processing devices.

### SUMMARY OF THE INVENTION

In accordance with the subject application, there is provided a system and method for configuration cloning for document processing devices.

Further, in accordance with the subject application, there is provided a system and method for continuously updating the configuration of a plurality of networked document processing devices.

Still further, in accordance with the subject application, there is provided a system and method for synchronized updating of document processing devices in order to maintain nearly identical configurations of the document processing devices.

Still further, in accordance with the subject application, there is provided a configuration cloning system for document processing devices. The system includes means adapted for receiving, into at least one document processing device, configuration data representative of a configuration thereof and means adapted for commencing operation of the at least one document processing device in accordance with received configuration data. The system further includes testing means adapted for testing received configuration data and transfer means adapted for selectively commencing a transfer of received configuration data to at least one additional document processing device via an associated network in accordance with an output of the testing means.

In one embodiment, the testing means includes means adapted for testing received configuration data against previously received configuration data. In another embodiment, the testing means further includes means adapted for testing acceptability of conditions for communication of received configuration data to the at least one additional document processing device.

In another embodiment, the transfer means further includes means adapted for transferring received configuration data to the at least one additional document processing device. In yet another embodiment, the transfer means includes means adapted for enabling a file download request to be issued from the at least one additional document processing device, and means adapted for communicating the received configuration data to the at least one additional document device upon receipt of a file download request therefrom.

In yet another embodiment, the system further includes means adapted for generating an event log in accordance with an output of the testing means.

Still further, in accordance with the subject application, there is provided a method for configuration cloning for document processing devices in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the configuration cloning system for document processing devices according to the subject application;

FIG. 2 is a block diagram illustrating controller hardware for use in the configuration cloning system for document processing devices according to the subject application;

FIG. 3 is a functional diagram illustrating the controller for use in the configuration cloning system for document processing devices according to the subject application;

FIG. 4 is a block diagram illustrating device hardware for use in the configuration cloning system for document processing devices according to the subject application;

FIG. 5 is a functional diagram illustrating the device for use in the configuration cloning system for document processing devices according to the subject application;

FIG. 6 is a flowchart illustrating a configuration cloning method for document processing devices according to the subject application; and

FIG. 7 is a flowchart illustrating a configuration cloning method for document processing devices according to the subject application.

### DETAILED DESCRIPTION OF THE PREFERRED EMBODIMENT

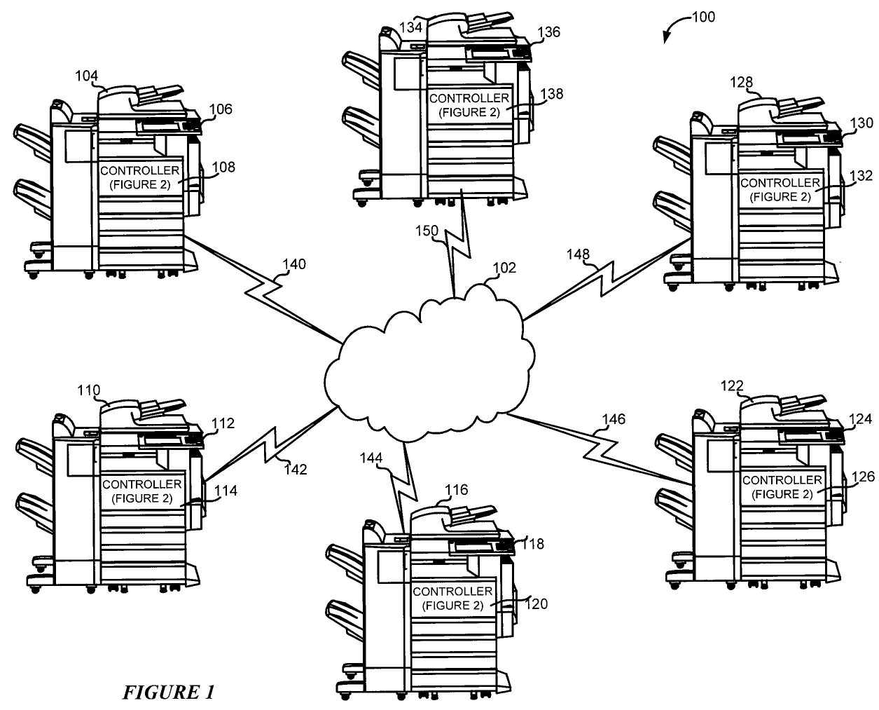

The subject application is directed to a system and method for configuration cloning for document processing devices. In particular, the subject application is directed to a system and method for continuously updating the configuration of a plurality of networked document processing devices. More particularly, the subject application is directed to a system and method for synchronized updating of document processing devices in order to maintain nearly identical configurations of the document processing devices. It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the configuration cloning system 100 for document processing devices in accordance with the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a system wherein each document processing device, explained in greater detail below, is connected, directly or wirelessly, to the next in serial, parallel, or the like, as will be known in the art.

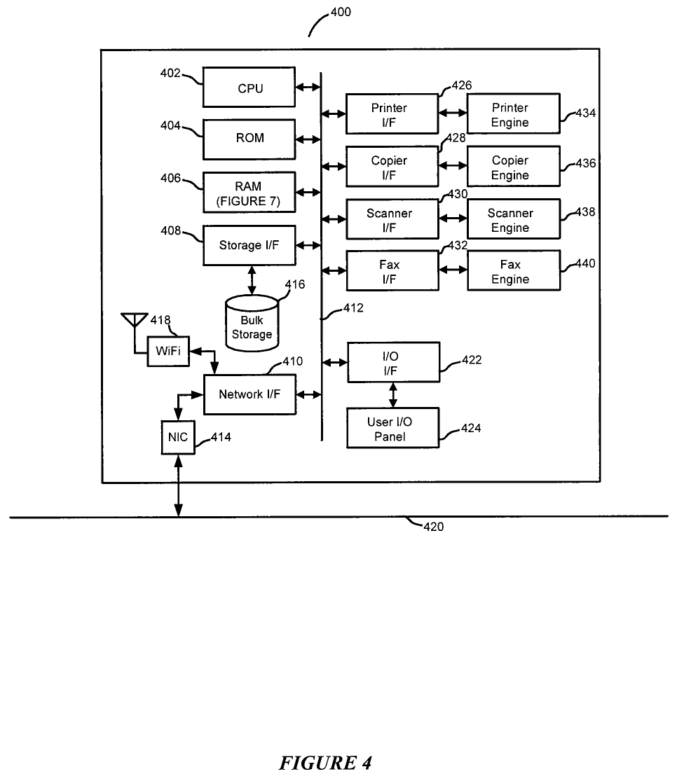

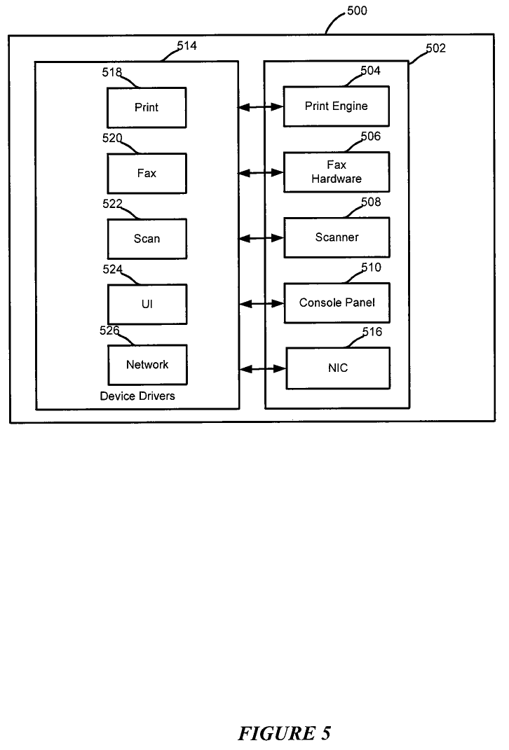

The system 100 also includes a first document processing device 104, a second document processing device 110, a third document processing device 116, a fourth document processing device 122, a fifth document processing device 128, and a sixth document processing device 134, each of which are depicted in FIG. 1 as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 110, 116, 122, 128, and 134 are suitably adapted to provide remote document processing services to external or network devices. Preferably, the document processing devices 104, 110, 116, 122, 128, and 134 include hardware, software, and any suitable combination thereof, configured to interact with an associated user, a networked device, each other, or the like. It will be appreciated by those skilled in the art that the display of six document processing devices in the system 100 is for example purposes only, and the subject application is capable of including fewer or greater numbers of devices in accordance therewith. The functioning of the document processing devices 104, 110, 116, 122, 128, and 134 will be explained in greater detail below with respect to FIG. 4 and FIG. 5.

According to one embodiment of the subject application, each document processing device 104, 110, 116, 122, 128, and 134 is suitably equipped to receive a plurality of portable storage media, including, without limitation, Firewire drive, USB drive, SD, MMC, XD, Compact Flash, Memory Stick, and the like. In the preferred embodiment of the subject application, each document processing device 104, 110, 116, 122, 128, and 134 further includes an associated user interface 106, 112, 118, 124, 130, and 136, respectively, such as a touch-screen, LCD display, touch-panel, alpha-numeric keypad, or the like, via which an associated user is able to interact directly with the corresponding document processing device 104, 110, 116, 122, 128, and 134. In accordance with the preferred embodiment of the subject application, each user interface 106, 112, 118, 124, 130, and 136 is advantageously used to communicate information to the associated user and receive selections from the associated user. The skilled artisan will appreciate that the user interfaces 106, 112, 118, 124, 130, and 136 comprise various components, suitably adapted to present data to the associated user, as are known in the art. In accordance with one embodiment of the subject application, the user interfaces 106, 112, 118, 124, 130, and 136 comprise a display, suitably adapted to display one or more graphical elements, text data, images, or the like, to an associated user, receive input from the associated user, and communicate the same to a backend component, such as the controllers 108, 114, 120, 126, 132, and 138, as explained in greater detail below. Preferably, the document processing devices 104, 110, 116, 122, 128, and 134 are communicatively coupled to the computer network 102 via suitable communications links 140, 142, 144, 146, 148, and 150, respectively. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

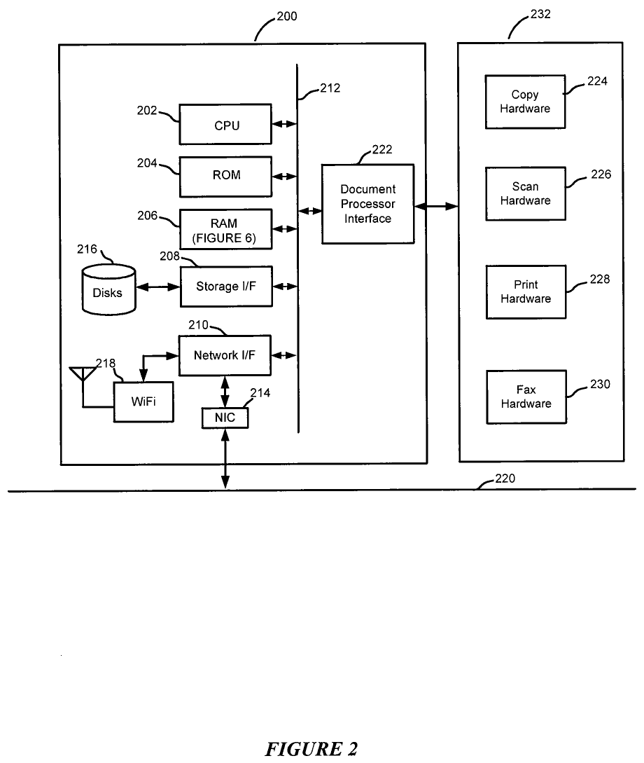

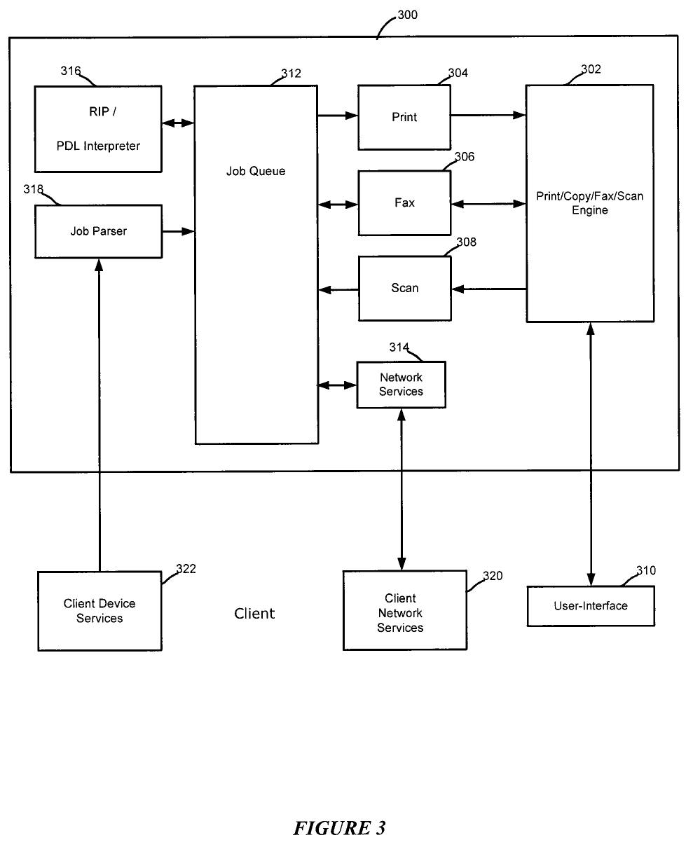

In accordance with the subject application, each document processing device 104, 110, 116, 122, 128, and 134 further incorporates a suitable backend component, designated as controllers 108, 114, 120, 126, 132, and 138, respectively, suitably adapted to facilitate the operations of the associated document processing devices 104, 110, 116, 122, 128, and 134, as will be understood by those skilled in the art. Preferably, the controllers 108, 114, 120, 126, 132, and 138 are embodied as hardware, software, or any suitable combination thereof, configured to control the operations of the corresponding document processing device 104, 110, 116, 122, 128, and 134, facilitate the display of images via the corresponding user interface 106, 112, 118, 124, 130, and 136, direct the manipulation of electronic image data, and the like. For purposes of explanation, the controllers 108, 114, 120, 126, 132, and 138 are used to refer to any myriad of components associated with the document processing devices 104, 110, 116, 122, 128, and 134, including hardware, software, or combinations thereof, functioning to perform, cause to be performed, control, or otherwise direct the methodologies described hereinafter. It will be understood by those skilled in the art that the methodologies described with respect to the controllers 108, 114, 120, 126, 132, and 138 are capable of being performed by any general purpose computing system, known in the art, and thus the controllers 108, 114, 120, 126, 132, and 138 are representative of such a general computing device and are intended as such when used hereinafter. Furthermore, the use of the controllers 108, 114, 120, 126, 132, and 138 hereinafter is for the example embodiment only, and other embodiments, which will be apparent to one skilled in the art, are capable of employing the configuration cloning system and method for document processing devices of the subject application. The functioning of the controllers 108, 114, 120, 126, 132, and 138 will better be understood in conjunction with the block diagrams illustrated in FIGS. 2 and 3, explained in greater detail below.

Turning now to FIG. 2, illustrated is a representative architecture of a suitable backend component, i.e., the controller 200, representative of each controller 108, 114, 120, 126, 132, and 138 shown in FIG. 1, on which operations of the subject system 100 are completed. The skilled artisan will understand that the controllers 108, 114, 120, 126, 132, and 138 are representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with the bus 212 is a document processor interface 222. Document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device 104, 110, 116, 122, 128, and 134 that includes the controller 200 of FIG. 2, (shown in FIG. 1 as the controllers 108, 114, 120, 126, 132, and 138), as an intelligent subsystem associated with a document processing device. In the illustration of FIG. 3, controller function 300 in the preferred embodiment includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These devices facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, illustrated is a representative architecture of a suitable device 400 (representative of the devices 104, 110, 116, 122, 128, and 134 of FIG. 1 on which operations of the subject system 100 are completed. Included is a processor 402, suitably comprised of a central processor unit. However, it will be appreciated that the processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by processor 402.

A storage interface 408 suitably provides a mechanism for volatile, bulk or long term storage of data associated with the device 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the device 400 to communicate to other devices. Network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and network subsystem 410 is suitably accomplished via a bus data transfer mechanism, such as illustrated by bus 412.

Suitable executable instructions on the device 400 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 422 to a user input/output panel 424 as will be appreciated by one of ordinary skill in the art.

Also in data communication with bus 412 are interfaces to one or more document processing engines. In the illustrated embodiment, printer interface 426, copier interface 428, scanner interface 430, and facsimile interface 432 facilitate communication with printer engine 434, copier engine 436, scanner engine 438, and facsimile engine 440, respectively. It is to be appreciated that the device 400 suitably accomplishes one or more document processing functions. Systems accomplishing more than one document processing operation are commonly referred to as multifunction peripherals or multifunction devices.

Turning now to FIG. 5, illustrated is a suitable document processing device 500 for use in connection with the disclosed system. FIG. 5 illustrates suitable functionality of the hardware of FIG. 4 in connection with software and operating system functionality as will be appreciated by one of ordinary skill in the art. The document processing device 500 suitably includes an engine 502 which facilitates one or more document processing operations.

The document processing engine 502 suitably includes a print engine 504, facsimile engine 506, scanner engine 508 and console panel 510. Print engine 504 allows for output of physical documents representative of an electronic document communicated to the processing device 500. The facsimile engine 506 suitably communicates to or from external facsimile devices via a device, such as a fax modem.

The scanner 508 suitably functions to receive hard copy documents and in turn image data corresponding thereto. A suitable user interface, such as the console panel 510, suitably allows for input of instructions and display of information to an associated user. It will be appreciated that the scanner 508 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 5, the document processing engine 502 also comprises an interface 516 with a network via driver 526, suitably comprised of a network interface card. It will be appreciated that a network thoroughly accomplishes that interchange via any suitable physical and non-physical layer, such as wired, wireless, or optical data communication.

The document processing engine 502 is suitably in data communication with one or more device drivers 514, which device drivers allow for data interchange from the document processing engine 502 to one or more physical devices to accomplish the actual document processing operations. Such document processing operations include one or more of printing via driver 518, facsimile communication via driver 520, scanning via driver 522 and a user interface functions via driver 524. It will be appreciated that these various devices are integrated with one or more corresponding engines associated with the document processing engine 502. It is to be appreciated that any set or subset of document processing operations are contemplated herein. Document processors which include a plurality of available document processing options are referred to as multi-function peripherals.

In operation, configuration data is first received by at least one document processing device representing a suitable configuration for implementation thereon. The document processing device then commences operations in accordance with the received configuration data. The configuration data is then tested by the document processing device. Depending upon the outcome of the testing by the document processing device, the received configuration data is transferred to at least one additional document processing device via a computer network.

In accordance with one example embodiment of the subject application, a document processing device, for example, a first document processing device 104, receives configuration data representing a new, modified, or updated configuration, via the computer network 102, from an administrator directly at the first document processing device 104, or the like. It will be understood by those skilled in the art that the first document processing device 104 is used herein for example purposes only, and the subject application is capable of implementation using any of the document processing devices 104, 110, 116, 122, 128, or 134. The first document processing device 104 then commences operations using the new configuration stipulated by the received configuration data. It will be appreciated by those skilled in the art that suitable configuration data includes, for example and without limitation, software, hardware configurations, device drivers, data of interest, or the like. The received configuration data, via which the first document processing device 104 is operating, is then tested via any suitable means. Preferably, the first document processing device 104, via a suitable backend component, such as the controller 108, verifies, for example and without limitation, that a pre-specified period of time has elapsed since a certain event, e.g., since the first document processing device 104 has been updated, alerts issued after a pre-specified point in time, e.g., if any high severity alerts have been issued after a certain date/time, a system reboot after a pre-specified period of time, or other conditions, e.g., events combined recursively using AND, OR, and NOT Boolean operators, or the like.

A determination is then made whether conditions on the network 102, triggering events, or other testing events, permit the transfer of the configuration data to at least one other document processing device. The skilled artisan will appreciate that the subject application is capable of instituting a master-clone mode of operation wherein the first document processing device 104 functions as the master node and each of the other compatible document processing devices 110, 116, 122, 128, and 134 are clones, i.e., any changes made to the first document processing device 104 will be replicated by the clone document processing devices 110, 116, 122, 128 and 134, or a peer-to-peer mode of operation, wherein any change made to any one of the document processing devices 104, 110, 116, 122, 128, or 134 will be replicated indiscriminately on each of the other document processing devices 104, 110, 116, 122, 128, or 134. In the event that the first document processing device 104 determines that conditions are not acceptable for transferring configuration data, an event log is generated reflecting the failure to update the remaining document processing devices 110, 116, 122, 128, and 134. The skilled artisan will appreciate that the use of the first document processing device 104 is for example purposes only and any of the other document processing devices 110, 116, 122, 128, and 134 are equally capable of functioning as a master node or the originating node in a peer-to-peer mode of operation.

Once the first document processing device 104 determines that the conditions are acceptable for transmission of the configuration data, a determination as to the type of transfer must be made, e.g., whether a push of the configuration data to each remaining document processing devices 110, 116, 122, 128, and 134 or a pull of the configuration data from the first document processing device 104 by the remaining document processing devices 110, 116, 122, 128, and 134 is to be made. The skilled artisan will appreciate that any one or more of the other document processing devices 110, 116, 122, 128, and 134 is capable of being the additional document processing device to receive configuration data from the first document processing device 104. When the a push-type of operation is to be made, the first document processing device 104 communicates the configuration data to a selected one of the other document processing devices 110, 116, 122, 128, and 134 via the computer network 102. The skilled artisan will appreciate that such a push is capable of being directed to a single document processing device, or any number of associated document processing devices communicatively coupled to the computer network 102.

When a pull-type of operation is indicated, such as by a network administrator, stipulated by the type of configuration data, or the like, a file download request is enabled to be issued by the remaining document processing devices 110, 116, 122, 128, and 134. That is, each document processing device 110, 116, 122, 128, and 134 is authorized to pull the configuration data, via a file download request, from the first document processing device 104. The first document processing device 104 then receives a file download request from at least one of the other document processing devices 110, 116, 122, 128, or 134 via the computer network 102. The first document processing device 104 then communicates the configuration data to the requesting device 110, 116, 122, 128, or 134 via the computer network 102, resulting in the receipt by the other document processing device 110, 116, 122, 128, or 134 of the configuration data. It will be appreciated by those skilled in the art that the above-described system thereby facilitates the synchronization of each compatible document process device 104, 110, 116, 122, 128, and 134 on the computer network 102 with respect to device configuration.

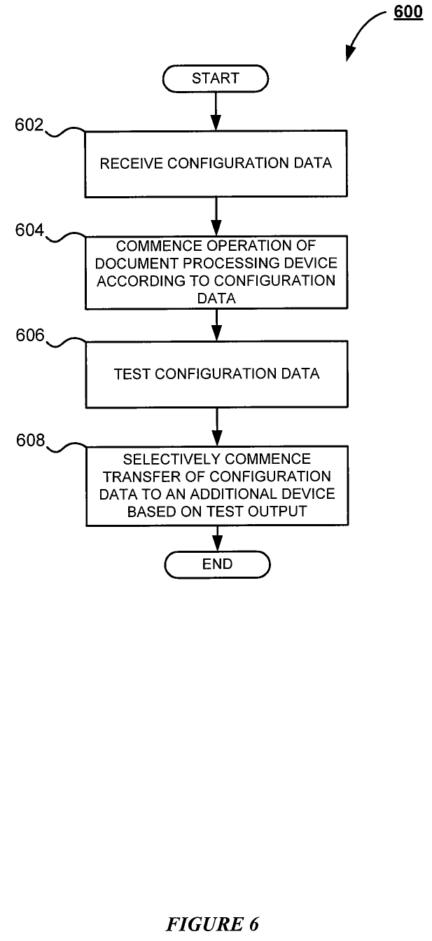

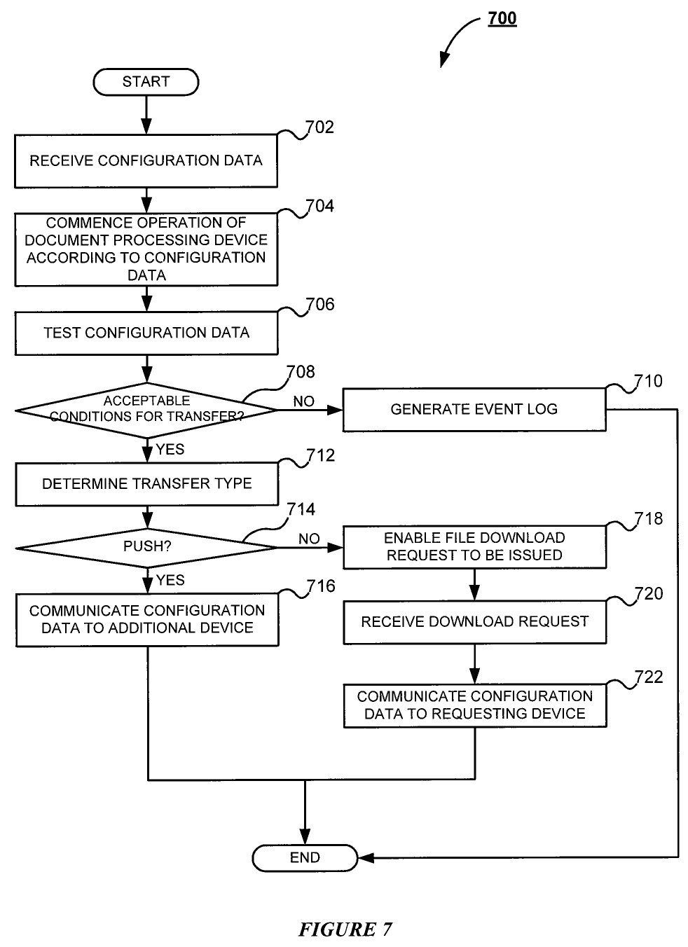

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a configuration cloning method for document processing devices in accordance with the subject application. Beginning at step 602, configuration data is received into at least one document processing device 104, 110, 116, 122, 128, or 134 representing a configuration of the document processing device 104, 110, 116, 122, 128, or 134. For purposes of example, reference will be made herein to the second document processing device 110 receiving the configuration data. Thus, the skilled artisan will appreciate that in accordance with the subject application, any of the document processing devices 104, 110, 116, 122, 128, or 134 is equally capable of functioning as the initial document processing device to receive the configuration data. At step 604, the second document processing device 110 commences operation in accordance with the received configuration data. The skilled artisan will appreciate that the second document processing device 110 alters, upgrades, modifies, amends, changes, or otherwise implements the received configuration data, resulting in a change of the second device 110 configuration to reflect the received configuration data. Flow then progresses to step 606, whereupon the configuration data is tested by the second document processing device 110. For example and without limitation, the second document processing device 110 determines whether conditions, as previously described above, allow for the transfer of the configuration data. A transfer of the configuration data is then selectively commenced to an additional document processing device 104, 116, 122, 128, or 134 via the computer network 102 in accordance with the result of the test by the second document processing device 110.

Referring now to FIG. 7, there is shown a flowchart 700 illustrating a configuration cloning method for document processing devices in accordance with the subject application. Beginning at step 702, configuration data is received by at least one of the document processing devices 104, 110, 116, 122, 128, or 134 communicatively coupled to the computer network 102. For purposes of example only, and without limitation, reference is made hereinafter to the third document processing device 116 receiving the initial configuration data. Thus, the skilled artisan will appreciate that in accordance with the subject application, any of the document processing devices 104, 110, 116, 122, 128, or 134 is equally capable of functioning as the initial document processing device to receive the configuration data. At step 704, the receiving document processing device 116 commences document processing operations in accordance with the received configuration data. The configuration data is then tested by the third document processing device 116 at step 706. The skilled artisan will appreciate that such testing is capable of including, for example and without limitation, determining the stability of the configuration, the compatibility of the configuration, the efficiency of the configuration, or the like.

A determination is then made at step 708 whether conditions are acceptable for a transfer of the configuration data to at least one additional document processing device 104, 110, 122, 128, or 134. When conditions are not acceptable for a transfer of the configuration data, flow proceeds to step 710, whereupon an event log is generated reflecting the failure of the transfer and/or the configuration data. When conditions are acceptable, flow progresses to step 712, whereupon the third document processing device 116, or a suitable component thereof, e.g., the controller 120, determines the type of transfer operation to be undertaken. A determination is then made at step 714 whether the type of transfer is a push-type operation. A positive determination at step 714, flow proceeds to step 716, whereupon the configuration data is communicated, i.e., pushed, to an additional document processing device 104, 110, 122, 128, or 134 via the computer network 102.

When the determination at step 714 is negative, i.e., a pull-type operation is required, flow proceeds to step 718, whereupon a file download request is enabled to be issued by an additional document processing device 104, 110, 122, 128, or 134. The additional document processing device 104, 110, 122, 128, or 134 then issues a download request to the third document processing device 116, which is received at step 720. Thereafter, at step 722, the configuration data is communicated to the requesting document processing device 104, 110, 122, 128, or 134.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A configuration cloning system for document processing devices comprising:
means adapted for receiving, into at least one document processing device, configuration data representative of a configuration thereof;
means adapted for commencing operation of the at least one document processing device in accordance with received configuration data;
testing means adapted for testing received configuration data; and
transfer means adapted for selectively commencing a transfer of received configuration data to at least one additional document processing device via an associated network in accordance with an output of the testing means.

2. The configuration cloning system for document processing devices of claim 1 wherein the testing means includes means adapted for testing received configuration data against previously received configuration data.

3. The configuration cloning system for document processing devices of claim 2 wherein the testing means further includes means adapted for testing acceptability of conditions for communication of received configuration data to the at least one additional document processing device.

4. The configuration cloning system for document processing devices of claim 1 wherein the transfer means further includes means adapted for transferring received configuration data to the at least one additional document processing device.

5. The configuration cloning system for document processing devices of claim 4 wherein the transfer means includes means adapted for enabling a file download request to be issued from the at least one additional document processing device, and means adapted for communicating the received configuration data to the at least one additional document device upon receipt of a file download request therefrom.

6. The configuration cloning system for document processing devices of claim 1 further comprising means adapted for generating an event log in accordance with an output of the testing means.

7. A configuration cloning method for document processing devices comprising the steps of:
receiving, into at least one document processing device, configuration data representative of a configuration thereof;
commencing operation of the at least one document processing device in accordance with received configuration data;
testing received configuration data; and
selectively commencing a transfer of received configuration data to at least one additional document processing device via an associated network in accordance with an output of the testing.

8. The configuration cloning method for document processing devices of claim 7 wherein the step of testing includes testing received configuration data against previously received configuration data.

9. The configuration cloning method for document processing devices of claim 8 wherein the step of testing includes testing acceptability of conditions for communication of received configuration data to the at least one additional document processing device.

10. The configuration cloning method for document processing devices of claim 7 wherein the step of transferring includes transferring received configuration data to the at least one additional document processing device.

11. The configuration cloning method for document processing devices of claim 10 wherein the step of transferring includes enabling a file download request to be issued from the at least one additional document processing device, and communicating the received configuration data to the at least one additional document device upon receipt of a file download request therefrom.

12. The configuration cloning method for document processing devices of claim 7 further comprising the step of generating an event log in accordance with an output of the testing means.

13. A computer-implemented method for configuration cloning for document processing devices comprising the steps of:
receiving, into at least one document processing device, configuration data representative of a configuration thereof;
commencing operation of the at least one document processing device in accordance with received configuration data;
testing received configuration data; and
selectively commencing a transfer of received configuration data to at least one additional document processing device via an associated network in accordance with an output of the testing.

14. The computer-implemented method for configuration cloning for document processing devices of claim 13 wherein the step of testing includes testing received configuration data against previously received configuration data.

15. The computer-implemented method for configuration cloning for document processing devices of claim 14 wherein the step of testing includes testing acceptability of conditions for communication of received configuration data to the at least one additional document processing device.

16. The computer-implemented method for configuration cloning for document processing devices of claim 13 wherein the step of transferring includes transferring received configuration data to the at least one additional document processing device.

17. The computer-implemented method for configuration cloning for document processing devices of claim 16 wherein the step of transferring includes enabling a file download request to be issued from the at least one additional document processing device, and communicating the received configuration data to the at least one additional document device upon receipt of a file download request therefrom.

18. The computer-implemented method for configuration cloning for document processing devices of claim 13 further comprising the step of generating an event log in accordance with an output of the testing means.
